(19) United States
(12) Patent Application Publication
(10) Pub. No.: US 2003/0202623 A1
(43) Pub. Date: Oct. 30, 2003

(54) Low cost elimination of long-lived nuclear waste

(76) Inventor: Heinrich W. Hora, Sydney (AU)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/454,460

(22) Filed: Jun. 3, 2003

Related U.S. Application Data
(63) Continuation of application No. 09/643,036, filed on Aug. 21, 2000.
Application No. 09/643,036 is a division of application No. 09/013,079, filed on Feb. 6, 1998, now abandoned.

(30) Foreign Application Priority Data
Feb. 3, 1997 (AU) P04879

(51) Int. Cl. G21J 1/00; G21B 1/00

(52) U.S. Cl. 376/100

(57) ABSTRACT

Aspects of the present invention include a non-metal, a hydrogen absorbing metal, a selected isotope to be exposed to ions of hydrogen or ions of isotopes of hydrogen, and a hydrogen source. The hydrogen source can be an electrolytic solution, a gas or plasma. In some embodiments the hydrogen absorbing metal covers the non-metal to form a microsphere. The hydrogen absorbing metal is positioned to contact the hydrogen source. Further, the hydrogen absorbing metal can be made of multiple layers of dissimilar metals with different Fermi energy levels. The multiple layers of metals have interfaces where swimming electron layers exist. Interfaces between the non-metal, hydrogen absorbing metal, and the hydrogen source also exist with swimming electron layers. The selected isotope is placed in these regions of swimming electron layers to be exposed to the ions of hydrogen and its isotopes from the hydrogen source.

### CROSS-REFERENCE TO RELATED APPLICATIONS

This application is a continuation of pending U.S. patent application Ser. No. 09/643,036, filed Aug. 21, 2000, which is a divisional of U.S. patent application Ser. No. 09/013,079, filed Jan. 30, 1998, now abandoned, which claims priority from Australian Provisional Application No. P04879, filed Feb. 3, 1997.

### FIELD OF THE INVENTION

This relates to equipment with large surfaces or interfaces of layers of materials which have ability to absorb high concentrations of hydrogen or of its isotopes from electrolytic or other sources, and where long lived radioactive isotopes or isotopes of neptunium, plutonium, americium or curium are incorporated into the materials or into their support and non dangerous isotopes are produced. Incorporation of other specially selected elements leads to the low cost generation of rare isotopes needed for all kinds of medical and industrial purposes. In other respects, the invention relates to exposing selected isotopes to hydrogen ions.

### BACKGROUND OF THE INVENTION

The necessity of eliminating long-lived radioactive isotopes and that of plutonium is indeed great. The current lowest cost and environmentally least dangerous (avoiding the emission of carbon dioxide in the atmosphere and subsequent global warming) and safest (using e.g. a passive reactor control: H. Hora and G. H. Miley, U.S. Pat. No. 5,319,688 or the scheme of Edward Teller, Laser Interaction and Related Plasma Phenomena, AIP Conference Proceedings No. 318, G. H. Miley ed. (Am. Inst. Phys., New York 1994) p.3) large scale energy production is using nuclear fission reactors. Nevertheless there are problems involved with handling radioactive waste products. Though there are several preliminary solutions available and being used, the costs are still very high and the implication of nuclear proliferation for production of nuclear explosives from gerneration of plutonium has to be considered. The final solution of complete eliminating long lived nuclear waste or of plutonium has not been available before. Particle beam treatment, which would solve the problem, is by orders of magnitudes too expensive.

Most of the chemical elements into which the fissioning uranium or plutonium nuclei split are—apart from stable nuclei—mostly short-lived radioactive isotopes which rather quickly decay into stable nuclei. The problems are the remaining long-lived nuclei, of which the following ones are mentioned, giving the half life in brackets: 99Tc (2.13x105y), 126Sn (1.1x105y), 129I (1.7x107y), 135Cs (2.3x106y), 107Pd (6.5x106y), 93Zr (1.5x106y).

A GW(electric) power station produces per year e.g. 257 kg of the mentioned technetium isotope or 59.4 kg of the mentioned iodine (Jean Tommasi et al. Nuclear Technology, Vol. 111, p. 133 (1995)). Furthermore the generated nuclei near uranium are in most cases long-lived too. A TRU reactor of 900 MW(electric) produces per year 138 kg plutonium(239), 52.8 kg plutonium(240), 10 kg neptunium(237), 5.1 kg americium 241 or 0.7 kg curium(244) and other neighbor isotopes in smaller quantities. The proliferation problem is a very important international issue. Plutonium(239) can be processed into mixed oxide (MOX) and then used in power reactors as fuel. This is what is being done e.g. in Japan which is buying this plutonium as an energy source for the future. Of the 430 civilian power reactors 800 tonnes of plutonium is in the waste and 200 tonnes were reprocessed into MOX. In the weapons arsenal there are 400 tonnes available from the preceding disarmament procedures (Nature 384, 599 (1996)). Nevertheless there seem to be good reasons by the US Department of energy, not to follow the use of plutonium as MOX for energy production but to eliminate it by vitrification and to store this though this potentially includes that the stored samples may be removed from their hidden places and the chemically easily extracted plutonium may be used for weapons by questionable governments or criminal powers.

For the obvious desire to fully eliminate plutonium by nuclear transmutation into chemically different nuclei, e.g. uranium where the isotopes can be molten into other uranium from where any isotope separation is exceedingly expensive and difficult, is an important aim. These kind of nuclear transmutations are indeed possible by using ion beams with ions of more than 10 MeV per nucleon or spallation processes with up to 10 GeV protons. In view of the very expensive accelerators needed for this purpose and in view that the ion currents there are rather small, there is no economic possibility in sight from this side. The invention described in this patent provides a low cost technique to eliminate plutonium as well as a nuclear transmutation of other long-lived isotopes appearing in high quantities in nuclear waste for transmutation into stable isotopes.

The electrolytic cell described in U.S. Pat. No. 5,494,559 ('559) was invented for the electrolysis of water and for the production of heat. Using these cells it has been observed in the Miley-Patterson experiment (G. H. Miley and J. A. Patterson, Nuclear Transmutation in Thin-Film Nickel coatings undergoing Electrolysis, Infinite Energy, Vol. 2, July-August No. 9, p. 19 (1996)) that nuclear transmutations are produced. All these reactions occurred within the host materials as described before in U.S. '559 and without adding any other material into the reaction apart from the protons or deuterons which were solved into the host material. The host materials are metals like palladium, nickel, titanium and a few others which have the ability to solve hydrogen or its isotopes in high quantities, e.g. one per host atom or even more.

The physical mechanisms of the state of the solved hydrogen atoms is considered rather different by different authors. Some assume that the hydrogen stays in a fixed state within the lattice of the host metal. The theoretical background for the above mentioned Miley-Patterson experiment is based on the model that the hydrogen is ionized and the hydrogen ions are a kind of an exotic Mawellian gas within the host metal whose very few energetic ions according to the Maxwellian distribution are reacting in a distance of few picometer where they have to have a screening of their Coulomb repulsion by a factor e.g. of 14. This is preferrably possible in the swimming electron layers at the surface of the metal or at the interface between a set of metal layers whose Fermi energy is different (H. Hora, et al, Physics Letters AA175, 138 (1993)). The advantage to use multilayers of host metals with different Fermi-levels was published before as explained in the references of the just mentioned publications.

The new phenomenon which appeared in the Miley-Patterson experiment is that the ions of the hydrogen or of its isotopes did not only react in between as claimed by numerous authors resulting in helium or tritium and producing considerable amounts of energy per nuclear reaction. The new phenomenon was that a large number of isotopes from all ranges of the periodic table were produced. This is a new physical phenomenon which is called low energy nuclear reaction (LENuR).

### BRIEF SUMMARY OF THE INVENTION

The essential novity against all the preceeding experiments and knowledge consists in the fact that instead of using the system consisting of the host metal plus hydrogen or of isotopes, other nuclides are added. This invention is using additional materials incorporated in the metal layers with high absorption of hydrogen or its isotopes or in the support material on which the layers are produced. The additional materials are then included in the nuclear reaction processes and the selection of isotopes provide the transmutation into desired other isotopes. The selected isotopes are either undesired long-lived, or such which are dangerous with respect to nuclear proliferation, or the desired isotopes are stable ones and not dangerous. The selected isotopes can also be such that the desired isotope is radioactive for use in all kinds of scientific, technological or medical applications.

The support material can be microspheres of glass or plastics but can be also of any other material which surface is prepared for the deposition of the metal layers of the host material. The incorporation of the additional materials into the support material and into the metal layers is being performed by alloying or solving.

It is therefore an object of this invention to utilize preferably glass microspheres as support and coats of palladium, nickel, titanium, cerium or mixtures of these as layers and to incorporate isotopes as described in the section “Background of the Invention” or similar of such or other desired nuclear transmutations.

It is yet another object to produce heat during the LENuR reaction as seen as example in an electrolytic cell where the coated and isotope loaded microspheres are treated with respect to the hydrogen or its isotopes.

In other respects, aspects of the invention are directed to exposing selected isotopes to hydrogen ions and ions of hydrogen isotopes.

### BRIEF DESCRIPTION OF THE DRAWINGS

FIG. 1 is a cross-sectional schematic drawing generally illustrating microspheres of a depicted embodiment of the present invention.

### DETAILED DESCRIPTION OF THE INVENTION

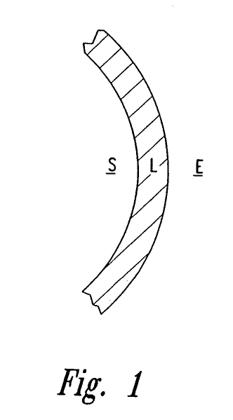

FIG. 1 describes the constitution of the microspheres. The Layer S is the support consisting of polymeric material or of glass, ceramics, or of metal, pure or alloyed. The layer L is made of palladium, nickel, titanium, cerium or one of the well known metals which absorb hydrogen or its isotopes in concentrations above 1%. The electrolyte E is used as described in U.S. '559 and operated there for electrolysis.

The electrolyte E is either a solution of ordinary water or of heavy water depending on the desire whether a proton (p-) or a deuteron (d-) reaction for the incorporated isotopes in L or S are desired. The low energy nuclear p- or d-reactions occur at the interfaces between the layers and their support or at the layer surface against the electrolyte. Volume reactions of the low energy type are also possible. Further to the initiating p- or d-reactions there are secondary nuclear reactions of the nuclei of the generated isotopes with other nuclei in the materials L and S. Significant cases of nuclear transmutation of long-lived isotopes incorporated into L and S are the following

99Tc(p,α)96Mo+6.38 MeV; 99Tc(d,α) 97Mo+10.86 MeV

leading to stable nuclei. Also the following reactions lead to stable transmutation products of 129I(p,α)126Te(+6.47MeV); 129I(d,α)127Te(+10.46MeV); 135Cs(p,α) 132Xe(+6.34MeV); 135Cs(d,α)133Xe(+10.7MeV); 107Pd(p,α)104Rh(+3.47MeV); 107Pd(d,α)105Rh (+10.17MeV) and 93Zr(p,α)90Y(+4,26MeV). In some cases, as e.g. 126Sn(p,α)123In (+2.278MeV); 126Sn(d,α)124In(+5,79MeV) result in fast beta decay products which finally transmute to the stable 123Sb and 124Sn respectively. The d-reaction with 93Zn can not be used since it arrives at long lived 91Nb if this is then not eliminated in the same way as described with the other long-lived isotopes.

For the elimination of the most important plutonium isotopes we have the following reactions. The following isotope with a half life of 2.4x104 y reacts in the following way

239Pu+p=236Np+4He+10.13 MeV

239Pu+d=237Np+4He+14.42 MeV

while the following isotopes with a half life of 6537 y reacts as

240Pu+p=237Np+4He+10.19 MeV

The isotopes neptunium(236) and neptunium(237) with the half lives of 1.55x105 y and 2.14x105 y are considered as harmless but there is the transmutation possible in the same way by the methods of this invention

237Np+p=234U+4He+11.67 MeV

to reach a uranium isotope which again is harmless since this can be molten into other uranium.

Instead of an electrolyte as E, one can also use gas or plasma of hydrogen or deuterium or tritium and vary its equilibrium temperature over a wider range from its melting point up to many hundreds of degrees centigratde, just that the layers L and their support S do not melt. Instead of the plasma one can also use chemical compounds with hydrogen and/or its isotopes from which the hydrogen dissociates at higher temperatures of operation. Instead of the microspheres one can use also highly dispersed palladium (palladium black) with a micro granulation of e.g. 0.5 mm diameter granulates or clusters of palladium, nickel, titanium or similar highly hydrogen absorbing metal. These granulates can also be produced as clusters with much smaller diameter by the usual spray methods of cluster generation. According to this invention one provides the inclusion of the additional material in these cluster generation processes or uses related methods.

According to the invention, the incorporation of the additional (e.g. long-lived, plutonium, or otherwise interesting) nuclei for the transmutation can be performed by condensing these atoms or chemical compounds of these atoms onto the surface of the microspheres, or the highly dispersed metals. For the surface processes of the nuclear transmutation using the Coulomb screening by the swimming surface layers of the electrons the simple presence of the condensate is sufficient. But for improving the efficiency of the transmutation reactions, a diffusion for the incorporation of the additional atoms is spreading the additional material into the surface area of the layers L by thermal diffusion processes. This all is related to the surface processes of L or of the highly dispersed hydrogen absorbing metals. For the case of using support material S the additional nuclei as atoms or chemical compounds will first be desposited or condensed by evaporation on S before the layers L are being attached to S. Again a further heat treatment improves the process by providing a thermal diffusion of the additional atoms into the depth of S and L near the interface between S and L.

If L consists of a multilayer structure with a number of interfaces, e.g. Ni—Pd—Ni—Pd—Ni etc., for providing the swimming electron layer screening, the additional atoms either are moved mechanically to these interfaces from the interface S-L or the surface E—L by thermal diffusion or the additional nuclei as atoms or chemical compounds are deposited or condensed at each interface of the metals (e.g. Ni, Pd) between each process of the deposition of these multilayers of L.

In view of the large amounts of nuclear waste transmutation or the plutonium extinction to be treated by the surface process of this invention, the techniques for producing largest possible surfaces are used and larger scale reaction plants are leading to a low cost solution for long-lived nuclear waste and for a low cost extinction for plutonium.

The present invention provides a low cost elimination of long lived nuclear waste from nuclear fission power stations, or of the elimination of plutonium and neighbour elements, or the generation of nuclear isotopes by the additional incorporation of these elements into the reaction areas for low energy nuclear reactions caused by protons or deuterons in host metals. In other respects, the present invention provides enhanced systems and methods for exposing selected isotopes to hydrogen ions.

I claim:

1. A system for exposing one or more selected isotopes to ions of hydrogen or ions of an isotope of hydrogen, the system comprising:
a hydrogen source comprising at least hydrogen or an isotope of hydrogen; and
a plurality of structures, each structure having an external surface, at least a portion of the external surface of each structure contacting the hydrogen source, each structure comprising:
a hydrogen absorbing metal
a selected isotope other than the hydrogen absorbing metal, the selected isotope to be exposed to ions of hydrogen or ions of an isotope of hydrogen, the selected isotope from a potential isotope set including I129, Cs135, Xe132, Pd107, Zr93, Tc99, and Sn126, the selected isotope coupled to the hydrogen absorbing metal.

2. The system of claim 1 wherein the hydrogen source is a gas.

3. The system of claim 1 wherein the hydrogen source is a plasma.

4. The system of claim 1 wherein the hydrogen source is a chemical compound from which hydrogen, deuterium, tritium or another isotope of hydrogen disassociates at a temperature above a threshold temperature.

5. The system of claim 1 wherein the selected isotope contains a mixture of different types of isotopes.

6. The system of claim 1 wherein the selected isotope is coupled to the hydrogen absorbing metal by disassociation of the selected isotope from materials or compounds contacting the hydrogen absorbing metal.

7. The system of claim 1 wherein the support material comprises a microsphere.

8. The system of claim 7 wherein the microsphere is made of glass, ceramic, or plastic.

9. The system of claim 1 wherein each structure further comprises a support material having an external support surface, wherein the hydrogen absorbing metal has internal and external metal surfaces, the hydrogen absorbing metal covering at least a portion of the external support surface to form a support-metal interface.

10. The system of claim 9 wherein the selected isotope is incorporated into the support-metal interface by the selected isotope contacting portions of the external support surface and the internal metal surface thereby coupling the selected isotope to the hydrogen absorbing metal.

11. The system of claim 9 wherein the selected isotope is incorporated into the support-metal interface by the selected isotope being incorporated into at least one of a portion of the support material extending from the external support surface and a portion of the hydrogen absorbing metal extending from the internal metal surface thereby coupling the selected isotope to the hydrogen absorbing metal.

12. The system of claim 9 wherein the selected isotope covers a portion of the external metal surface thereby coupling the selected isotope to the hydrogen absorbing metal.

13. The system of claim 9 wherein the selected isotope is incorporated into the hydrogen absorbing metal extending from the external metal surface thereby coupling the selected isotope to the hydrogen absorbing metal.

14. The system of claim 9 wherein the hydrogen absorbing metal comprises at least one pair of a first and a second metal, the first metal and the second metal having different Fermi energies, each pair of first and second metals forming a metal-metal interface, each of the first and second metals having an interface surface adjacent the metal-metal interface.

15. The system of claim 14 wherein the first metal is Ni and the second metal is Pd.

16. A system for exposing one or more selected isotopes to ions, the system comprising:
a hydrogen source being a gas, plasma, or chemical compound comprising at least hydrogen or an isotope of hydrogen; and
a plurality of structures each having an external surface, at least a portion of each structure contacting the hydrogen source, each structure comprising:
a hydrogen absorbing metal;
a selected isotope other than the hydrogen absorbing metal coupled to the hydrogen absorbing metal.

17. The system of claim 16 wherein the hydrogen source is a gas.

18. The system of claim 16 wherein the hydrogen source is a plasma.

19. The system of claim 16 wherein the hydrogen source is a chemical compound from which hydrogen, deuterium, tritium or another isotope of hydrogen disassociates at a temperature above a threshold temperature.

20. A system for exposing a selected isotope to ions of hydrogen or ions of an isotope of hydrogen, the system comprising:
a hydrogen source comprising at least hydrogen or an isotope of hydrogen; and
a plurality of structures each having an external surface, at least a portion of the external surface of each structure contacting the hydrogen source, each structure comprising:
a selected isotope; and
a hydrogen absorbing metal device other than the selected isotope coupled to the selected isotope.
